(19) United States
(12) Patent Application Publication
(10) Pub. No.: US 2005/0278518 A1
(43) Pub. Date: Dec. 15, 2005

(54) ELECTRONIC SYSTEM CAPABLE OF USING UNIVERSAL PLUG AND PLAY (UPNP) PROTOCOL TO UPDATE SOFTWARE PROGRAM AND METHOD THEREOF

(76) Inventors: Ming-Chih Ko, Taipei Hsien (TW); De-Jen Lu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 10/710,092

(22) Filed: Jun. 18, 2004

(30) Foreign Application Priority Data
Jun. 10, 2004 (TW) 093116723

(51) Int. Cl. G06F 9/00; G06F 9/24; G06F 15/177; G06F 9/445; G06F 1/12; G06F 13/42

(52) U.S. Cl. 713/1; 713/2

(57) ABSTRACT

An electronic system includes a network interface connecting the electronic system to a network, a non-volatile memory containing system software, and a CPU connected to the network interface and the non-volatile memory. The CPU discovers new software update components on the network using a universal plug and play (UPnP) protocol, downloads a selected software update component from the new software update components discovered on the network, and updates the non-volatile memory with the downloaded software update component. If the update should fail, a boot loader containing a network stack for a UPnP protocol can be used to reboot the electronic system using a backup software program discovered using the UPnP protocol. When booting, the CPU discovers new update components on the network using the UPnP protocol, downloads a selected update component from the new update components discovered on the network, and updates the non-volatile memory with the downloaded update component.

### BACKGROUND OF INVENTION

1. Field of the Invention

The invention relates to electronic systems, and more particularly, to an electronic system capable of using a universal plug and play (UPnP) protocol to update a software program in a non-volatile memory and an associated method of updating a software program of an electronic system using the UPnP protocol.

2. Description of the Prior Art

As technology progresses, electronic systems are increasingly used in daily life. Many electronic systems, particularly embedded systems and devices, employ non-volatile memory to store system software for the electronic system. Conventionally, it is sometimes required for the non-volatile memory to be updated with a new software update component. This requirement could arise, for example, if the manufacturer releases a software revision to fix bugs in the old version or to incorporate new features of the electronic system.

As an example of an electronic system, FIG. 1 shows a typical embedded system 100 comprising a CPU 102, a random access memory (RAM) 104, a boot loader 106, a re-movable storage device 108, and a non-volatile memory 110. The non-volatile memory 110 is illustrated in FIG. 1 as a flash memory 110, however this is for example only and other types of non-volatile memories are also acceptable. A system software program 112, also referred to as the system kernel, provides operating instructions for the CPU 102 and is stored in the flash memory 110. When the embedded system 100 is first powered on, the boot loader 106 is used to configure the CPU 102 to the correct operating mode and the CPU 102 eventually jumps to a starting address in the flash memory 110 corresponding to the beginning of the system software program 112. The CPU 102 executes the system software program 112 to finish the booting process for the embedded system 100 and begin normal operations.

If updated system software is released by the manufacturer of the embedded system 100, there are a variety of methods well known in the prior art to update the flash memory 110. One method involves physically returning the embedded system 100 to the manufacturer or repair shop to have the flash memory 110 reprogrammed. As this is time consuming and costly, updated system software will often be provided on a magnetic diskette or another removable medium such as a compact disc read-only memory (CDROM), which is delivered to registered users of the embedded system. In this case, the system software program 112 of the embedded system 100 provides a function allowing the user to manually update the flash memory 110 using a software update component loaded from the removable storage device 108. An enhancement of this update method that avoids having to maintain an accurate address list of all users of the embedded system 100 involves the manufacturer placing the software update component on a website. Users must periodically check the manufacturer's website for updates and download any new updated system software to manually update the flash memory 110 of the embedded system 100.

FIG. 2 shows a typical networked embedded system 200. The typical networked embedded system 200 contains the CPU 102, the random access memory (RAM) 104, the boot loader 106, and the flash memory 110 of the first typical embedded system 100 shown in FIG. 1. Additionally, a network-enabled system software program 206 is used by the CPU 102 in conjunction with a network interface 202 to allow the embedded system 200 to communicate with an attached network 204. The embedded system 200 periodically polls a specific server or a plurality of specific servers operated by the manufacturer of the embedded system 200 to check for updated system software. If updated system software is located on the server(s) polled by the embedded system 200, the embedded system 200 can automatically update the flash memory 110 directly from the network 204. Automatic network updates greatly reduce the cost of updating the flash memory 110 of a plurality of embedded systems 200 that are connected to a network, however, require polling of a preprogrammed list containing at least one server.

### SUMMARY OF INVENTION

According to the claimed invention, an electronic system is disclosed comprising a network interface connecting the electronic system to a network, a non-volatile memory containing system software, and a CPU connected to the network interface and the non-volatile memory. The CPU discovers available software update components on the network using a universal plug and play (UPnP) protocol, downloads a selected software update component from the available software update components discovered on the network, and updates the non-volatile memory with the downloaded software update component.

Also according to the present invention, a method is disclosed for updating a software program of an electronic system. The method comprises using a universal plug and play (UPnP) protocol to discover available update components for the software program on a network attached to the electronic system, selecting an update component from the available update components discovered on the network, downloading the selected update component, and updating the software program with the selected update component.

Also according to the present invention, an electronic system is disclosed comprising a network interface connecting the electronic system to a network, a non-volatile memory containing system software, a boot loader containing a network stack for a universal plug and play (UPnP) protocol, and a CPU connected to the network interface and the non-volatile memory. When booting, the CPU discovers new software update components on the network using the UPnP protocol, downloads a selected software update component from the new software update components discovered on the network, and updates the non-volatile memory with the downloaded software update component.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a typical embedded system according to prior art.

FIG. 2 is a typical networked embedded system according to the prior art.

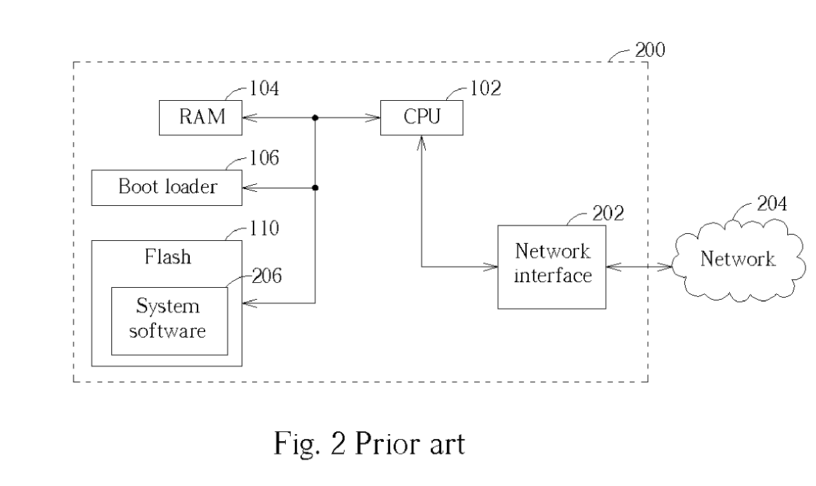

FIG. 3 is an electronic system according to a first embodiment of the present invention.

FIG. 4 is an electronic system according to another embodiment of the present invention.

FIG. 5 shows a flowchart describing a method of updating a software program of an electronic system according to the present invention.

### DETAILED DESCRIPTION

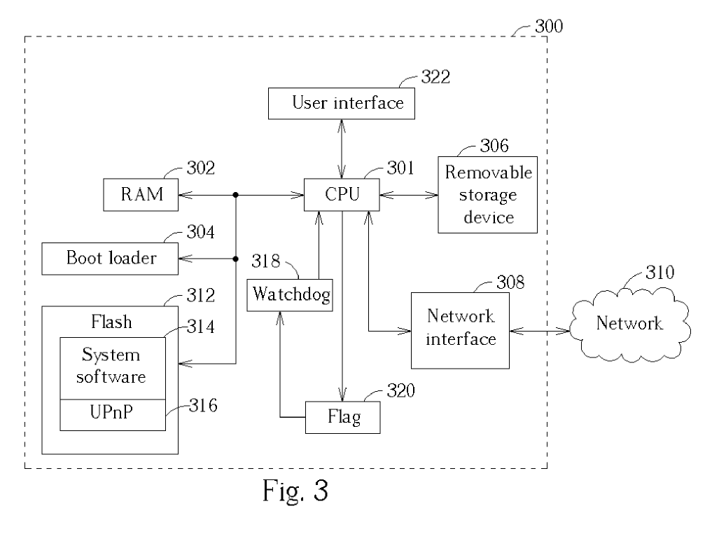

FIG. 3 shows an electronic system 300 according to a first embodiment of the present invention. The electronic system 300 comprises a CPU 301, a RAM 302, a boot loader 304, a removable storage device 306, a network interface 308, a watchdog timer 318, a non-volatile memory incomplete flag 320, a user interface 322, and a non-volatile memory implemented as a flash memory 312. A system software program 314, providing operating instructions for the CPU 301, is stored in the flash memory 312. The network interface 308 allows the electronic system 300 to physically communicate with an attached network 310, and the system software program 312 includes a universal plug and play (UPnP) stack 316 to allow UPnP based network access. When the electronic system 300 is first powered on, the boot loader 304 is used to configure the CPU 301 to the correct operating mode and the CPU 301 eventually jumps to a starting address in the flash memory 312 corresponding to the beginning of the system software program 314. The CPU 301 executes the system software program 314 to finish the booting process for the electronic system 300 and begin normal operations.

In the preferred embodiment of the present invention, throughout normal operations, the electronic system 300 uses the UPnP protocol to automatically discover new software update components for the system software program 314 on the attached network 310. UPnP discovery operations take place through the network interface 308 and servers on the network 310 hosting new software update components are located. The UPnP protocol automatically discovers new software update components and does not require the electronic system 300 to be preprogrammed with a list of specific servers on the network 310.

As new software update components are found, the CPU 301 calculates a path cost for each new software update component discovered. In one embodiment of the present invention, the path cost is calculated by looking at the internet protocol (IP) address of the server hosting the new software update component. A table or comparison chart is stored in the flash memory 312 and provides a path cost relating the IP address of the electronic system to the IP address of the server hosting the new software update component. In another embodiment of the present invention, the path cost is determined by the round trip time for a ping packet sent to the server hosting the new software update component. Servers having higher round trip times are assigned higher path costs. In this way, a fast server that is quick to respond to the electronic system 300 and that has a non-congested network route to the electronic system 300 will be assigned a lower path cost than a server taking a long time to respond or having a congested network route. In another embodiment, the path cost is determined by the number of network hops between the electronic system 300 and the server hosting the new software update component.

After a new software update component is found and the associated path cost for the new software update component is determined, a user of the electronic system is notified that an updated software component has been found and also shown the associated path cost. In the preferred embodiment, this notification occurs in real-time as each new software update component is discovered.

Following notification, in one embodiment of the present invention, the user of the electronic system can choose one of the already discovered software update components and initiate an update of the flash memory using the selected software update component. In another embodiment, the CPU 301 of the electronic system 300 automatically selects one of the available software update components. When using automatic selection performed by the CPU 301, the preferred embodiment of the present invention involves the CPU 301 selecting the software update component having the lowest path cost. In other embodiments, other selection criteria can be used such as favorite servers, approved servers, or non-busy servers.

Once one of the new software update components has been selected, the CPU 301 downloads the selected software update component from the attached network 310 through the network interface 308. To avoid incomplete writes to the flash memory 312, in the preferred embodiment of the present invention, the CPU 301 first downloads the selected software update component to the RAM 302. Additionally, in the preferred embodiment, before updating the flash memory 312, the CPU 301 first sets the non-volatile memory incomplete flag 320. The non-volatile memory incomplete flag 320 indicates to the watchdog timer 318 that the flash memory 312 is not properly programmed and the electronic system 300 will be unable to load the system software program 314 from the flash memory 316 should the electronic system 300 need to be rebooted. As the non-volatile memory illustrated in the first embodiment of the present invention, shown in FIG. 3, is implemented as the flash memory 312, the step of updating the flash memory 312 comprises first erasing the current contents of the flash memory 312 (or the contents of a specific partition of the flash memory 312) and then writing the new software update component to the erased flash memory 312 (or specific partition of the flash memory 312). In other embodiments having different types of non-volatile memory, different updating procedures may be used. For example, it may be possible to directly write the downloaded software update component to the non-volatile memory without first erasing the non-volatile memory.

After updating the flash memory 312 with the downloaded software update component, the CPU 301 unsets the non-volatile memory incomplete flag 320 to indicate to the watchdog timer 318 that the flash memory 312 has been properly programmed and that the electronic system 300 can load the system software program 314 from the flash memory 312.

In the preferred embodiment of the present invention, to ensure reliability, the watchdog timer 318 continuously monitors the non-volatile memory incomplete flag 320. If the time duration that the non-volatile memory incomplete flag 320 is set exceeds a predetermined time limit, the watchdog timer 318 assumes that the update process has failed and reboots the electronic system 300 using a backup software program. The backup software program may be stored on a magnetic disc, CDROM, or another external medium accessed through the removable storage device 306. In another embodiment of the present invention, the backup software component is stored on a separate partition of the flash memory 312 or in a separate non-volatile memory of the embedded system 300. The boot loader 304 may need to include a removable storage device driver (not shown) in order to reboot the electronic system using the removable storage device storing the backup software program in the event that the update process fails. The non-volatile memory incomplete flag 320, the watchdog timer 318, and the backup software component increase the reliability of updates preformed by the electronic system 300.

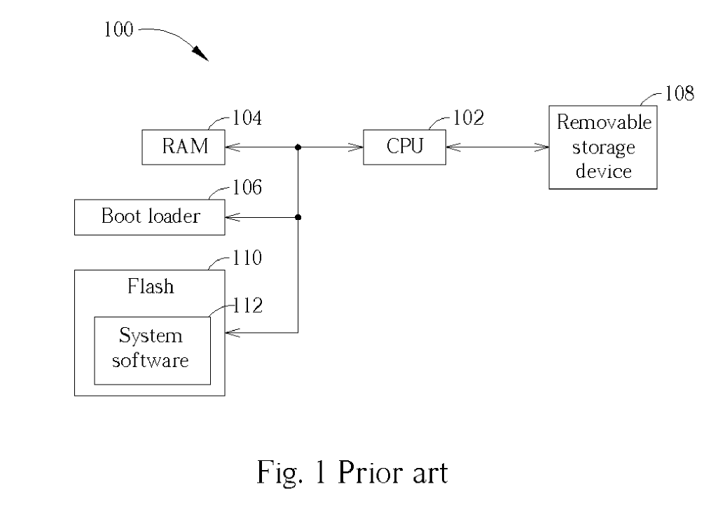

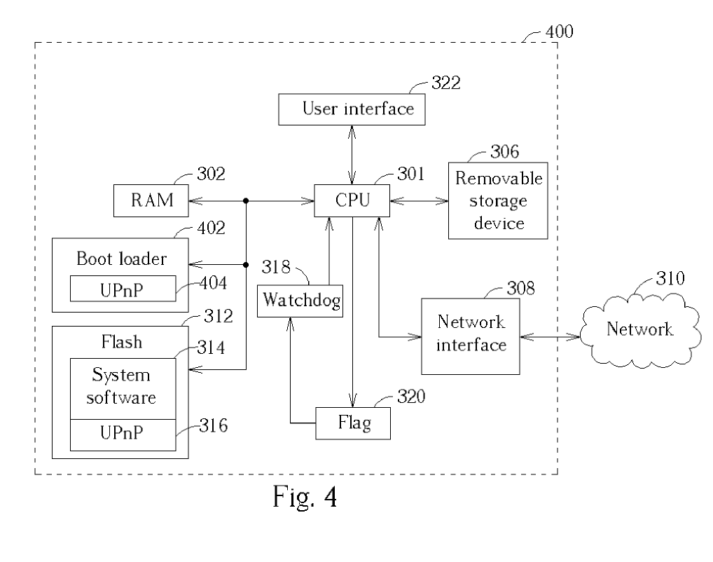

FIG. 4 shows an electronic system 400 according to another embodiment of the present invention. The embedded system 400 comprises similar components as previously described for FIG. 1, however, the boot loader 402 now also comprises a UPnP stack 404. In this embodiment, the remaining components have similar operation as previously described for FIG. 3 and, therefore, a repeated description is hereby omitted.

The advantage of including the UPnP stack 404 in the boot loader 402, is that if the update of the flash memory 312 fails, the electronic system 400 can boot from a backup software component discovered on the network 310 using the UPnP protocol. Furthermore, because the UPnP protocol is used, the electronic system 400 does not need to be preprogrammed with a list of network server addresses on the attached network 310. After booting from the backup software component discovered on the network 310, the electronic system 400 can proceed to update the flash memory 312 so that in the future the electronic system 400 can boot when disconnected from the network 310 or when no backup software programs can be discovered.

By using the UPnP protocol to discover new software update components, neither the user of the electronic system 300, 400 nor the electronic system 300, 400 itself need to know specific websites, network locations, filenames, or pointers containing system software updates. The UPnP protocol allows automatic discovery of new software update components and is ideally suited for a very dynamic network environment. Using the UPnP protocol according to the present invention to discover software update components allows fully automatic and trouble-free updating of a non-volatile memory of an electronic system connected to a network. The manufacturer or a support provider of the electronic system can change the server locations and network addresses at will, and the electronic system will still be able to perform automatic updates using the UPnP protocol.

A person skilled in the art will see many other uses of the present invention including using the UPnP protocol to update software programs in an electronic system other than system software programs such as the system kernel. As such, the present invention can be used to update any software program in any electronic system connected to a network using the UPnP protocol.

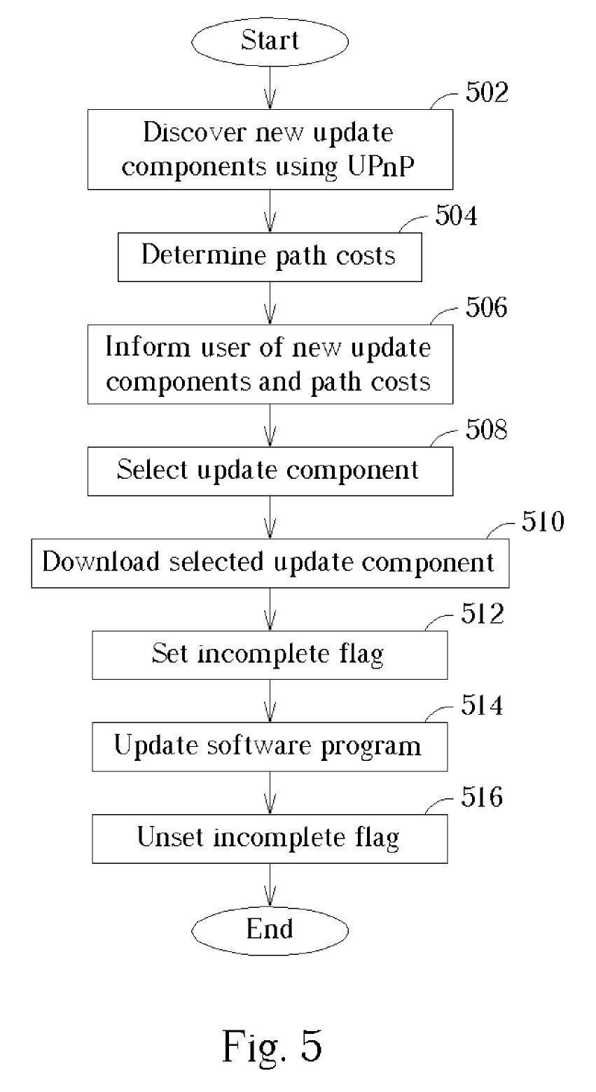

FIG. 5 shows a flowchart describing a method of updating a software program of an electronic system according to the present invention. The flowchart contains the following steps:

Step 502: Discover new update components available on a network connected to the electronic system using the universal plug and play (UPnP) protocol. In the preferred embodiment of the present invention, this step takes place in the background throughout normal operations of the electronic system requiring no invocation from a user of the electronic system. In another embodiment, the discovery step 502 is preformed during an update process, which is invoked by the user of the electronic system or a system timer. For each new update component discovered on the network using the UPnP protocol, proceed to step 504.

Step 504: Determine a path cost for the new update component discovered in step 502. The path cost can, for example, be determined by examining an IP address of a server hosting the new update component, a round trip time for a ping packet sent to the server hosting the new update component, the number of network hops between the electronic system and the server hosting the new update component, or another metric used to compare the suitability of network routes and server speeds for the different update components discovered in step 502. After the path cost has been determined, proceed to step 506.

Step 506: Inform the user of the electronic system of the update components discovered in step 502 and of the path costs determined in step 504. In the preferred embodiment of the present invention, step 506 occurs in real-time as new update components are discovered and their associated path costs are determined. Proceed to step 508.

Step 508: Select an update component and initiate the update process. In one embodiment of the present invention, the user of the electronic system selects an update component from the information presented in step 506 and initiates the update process by proceeding to step 510. In another embodiment, a program running on the electronic system automatically selects the update component having the lowest path cost and initiates the update process by proceeding to step 510.

Step 510: Download the selected software update component from the network. In the preferred embodiment of the present invention, the selected update component is first downloaded to a volatile memory such as a RAM in the electronic system. This prevents a failed download or failed network connection in the middle of the download from causing an incomplete update of the software program of the electronic system. When the selected update component has been downloaded, proceed to step 512.

Step 512: Set a non-volatile memory incomplete flag to indicate that the software program of the electronic system is not properly updated and proceed to step 514.

Step 514: Update the software program with the downloaded update component and proceed to step 516.

Step 516: Unset the non-volatile memory incomplete flag to indicate that the software program of the electronic system is now updated with the downloaded update component. This completes the update of the software program.

The preferred embodiment of the present invention method described in FIG. 5 allows for a watchdog timer to ensure the reliability of the software program update process. If the non-volatile memory incomplete flag should remain set for a time duration exceeding a predetermined value, being of longer time than is required to update the software program, the watchdog timer reboots the electronic system using a backup software program. As previously stated, the boot loader may include a re-movable storage device driver (not shown) in order to reboot the electronic system using the removable storage device storing the backup system software in the event that the software update process fails. The backup software program could be located in a separate partition of a non-volatile memory storing the software program, a separate non-volatile memory, or a removable storage medium such as a CDROM, a compact flash card, or a magnetic disc. In another embodiment of the present invention, the boot loader of the electronic system includes a network stack, which allows the electronic system to reboot by discovering backup system software on the network via the UPnP protocol if the software update process failed. The non-volatile memory incomplete flag and the watchdog timer allow a reliable update of a software program of the electronic system. However, in another embodiment, if reliability is not of primary concern, steps 512 and 516 can be removed to simplify the implementation.

Those skilled in the art will readily observe that numerous modifications and alterations of the device may be made while retaining the teachings of the invention. Accordingly, the above disclosure should be construed as limited only by the metes and bounds of the appended claims.

1. An electronic system comprising:
a network interface connecting the electronic system to a network;
a non-volatile memory containing system software; and
a CPU connected to the network interface and the non-volatile memory;
wherein the CPU discovers new software update components on the network using a universal plug and play (UPnP) protocol, downloads a selected software update component from the new software update components discovered on the network, and updates the non-volatile memory with the downloaded software update component.

2. The electronic system of claim 1, wherein the CPU further determines a path cost for each new software update component, each path cost relating the network separation distance of the electronic system and the new software update component, the selected software update component being the new software update component having the lowest path cost.

3. The electronic system of claim 2, wherein the path cost for a particular software update component is determined by examining an IP address of a server hosting the particular software update component, a round trip time for a ping packet sent to the server hosting the particular software update component, or the number of network hops between the electronic system and the server hosting the particular software update component.

4. The electronic system of claim 1, further comprising:
a user interface device;
wherein the CPU uses the user interface device to inform the user of each new software update component discovered on the network.

5. The electronic system of claim 4, wherein the CPU uses the user interface device to inform the user of new software update components in real-time as soon as they are discovered, the selected software update component being selected by the user through the user interface device.

6. The electronic system of claim 1, further comprising:
a non-volatile memory incomplete flag;
wherein before updating the non-volatile memory with the downloaded software update component, the CPU sets the non-volatile memory incomplete flag to indicate that the non-volatile memory is not properly programmed; and
after updating the non-volatile memory with the downloaded software update component, the CPU unsets the non-volatile memory incomplete flag to indicate that the non-volatile memory is properly programmed.

7. The electronic system of claim 6, further comprising:
a watchdog timer;
wherein the watchdog timer monitors the time duration that the non-volatile memory incomplete flag is set; and
if the non-volatile memory incomplete flag is set for a time duration exceeding a predetermined time limit, the watchdog timer reboots the electronic system using a backup software program.

8. The electronic system of claim 7, wherein the backup software program is located in a separate partition of the non-volatile memory, or a separate non-volatile memory.

9. The electronic system of claim 7, wherein the backup software program is located on a removable storage medium comprising a CDROM, a compact flash card, or a magnetic disc.

10. The electronic system of claim 7, further comprising:
a boot loader comprising permanent firmware used to boot the electronic system;
wherein the boot loader comprises a network stack including a UPnP stack and the backup software program is located on the network.

11. The electronic system of claim 1, wherein the electronic system is an embedded system, the software update component is the system software kernel for the embedded system, and the non-volatile memory is a flash memory.

12. A method of updating a software program of an electronic system, the method comprising:
using a universal plug and play (UPnP) protocol to discover new update components for the software program on a network attached to the electronic system;
selecting an update component from the new update components discovered on the network;
downloading the selected update component; and
updating the software program with the selected update component.

13. The method of claim 12, further comprising:
determining a path cost for each new update component, each path cost relating the network separation distance of the electronic system and the new update component;
wherein selecting an update component from the new update components discovered on the network comprises selecting the new update component having the lowest path cost.

14. The method of claim 13, wherein the path cost for a particular update component is determined by examining an IP address of a server hosting the particular update component, a round trip time for a ping packet sent to the server hosting the particular update component, or the number of network hops between the electronic system and the server hosting the particular update component.

15. The method of claim 12, further comprising informing the user of each new update component discovered on the network.

16. The method of claim 15, wherein the informing the user step occurs in real-time, and the user is informed of new update components as soon as they are discovered, the user selecting the update component from the new update components discovered on the network.

17. The method of claim 12, further comprising:
before updating the software program with the selected update component, setting a non-volatile memory incomplete flag to indicate that the software program is not properly updated; and
after updating the software program with the selected update component, unsetting the non-volatile memory incomplete flag to indicate that the software program is properly updated.

18. The method of claim 17, further comprising:
monitoring the time duration that the non-volatile memory incomplete flag is set; and
if the non-volatile memory incomplete flag is set for a time duration exceeding a predetermined time limit, rebooting the electronic system using a backup software program.

19. The method of claim 18, wherein the backup software program is located in a separate partition of a current non-volatile memory, or a separate non-volatile memory.

20. The method of claim 18, wherein the backup software program is located on a removable storage medium comprising a CDROM, a compact flash card, or a magnetic disc.

21. The method of claim 18, wherein a boot loader of the electronic system comprises a network stack including a UPnP stack and the backup software program is located on the network.

22. The method of claim 12, wherein the electronic system is an embedded system, and the software program is the system kernel for the embedded system.

23. An electronic system comprising:
a network interface connecting the electronic system to a network;
a non-volatile memory containing system software;
a boot loader containing a network stack for a universal plug and play (UPnP) protocol; and
a CPU connected to the network interface and the non-volatile memory;
wherein when booting, the CPU discovers new update components on the network using the UPnP protocol, downloads a selected update component from the new update components discovered on the network, and updates the non-volatile memory with the downloaded update component.
